(19) United States
(12) Patent Application Publication
(10) Pub. No.: US 2008/0125226 A1
(43) Pub. Date: May 29, 2008

(54) Online Gaming

(76) Inventor: Francis Emmerson, Edinburgh (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/583,811

(22) PCT Filed: Dec. 16, 2004
(86) PCT No.: PCT/IB04/04217

§ 371 Date: Oct. 23, 2007

(30) Foreign Application Priority Data
Dec. 22, 2003 (GB) 0329706.6

(51) Int. Cl. G06F 17/00

(52) U.S. Cl. 463/42; 463/30; 463/39

(57) ABSTRACT

An online gaming system enabling users connected to a communications network to interact with a computer game being played across the network, the system comprising at least one state engine for controlling the state of the game and at least one presentation engine for controlling the presentation to users of an output representing the state of the game; the state engine being arranged to enable one or more users to affect the state of the game by communicating with the state engine and thereby act as participant(s) in the game; and the presentation engine being arranged to enable at least one other user to affect the presentation of the output to one or more users acting as spectator(s) of the game by communicating with the presentation engine.

### FIELD OF THE INVENTION

The present invention is concerned with a wireless communication network arranged to provide an online gaming environment for users of the network.

### BACKGROUND OF THE INVENTION

The popularity of computer games and gaming consoles continues to increase, wherein the expectations of the general public demand improved audio-visual effects. The area of computer graphics is indeed a very challenging and fast paced one, in that designers are constantly striving to improve processing platforms and streamline computer code so that the huge amounts of data can be processed more efficiently, thereby resulting in an improved product for the gaming community.

There are various different aspects to most modern computing games. Some of these could include for example; cameras, audio, video, networking, gaming engines, etc. A brief description of these various elements now follows.

The camera angle determines how a computer game will be viewed by a client. In some games the camera is shown from the player's viewpoint, whereas in other games the camera is able to show different angles which could for example be selected using a particular combination or sequence of cursor clicks. It will also be appreciated that many computer games have many different camera angles and that a computer is able to zoom in or zoom out of the scene.

The audio effects also need to be carefully synchronised with the computer graphics that are generated on screen. There are various API (application programming interface) standards for audio programming, for example OpenAL™ and DirextX Audio™.

All of these features contribute towards the total gaming experience and designers are constantly trying to find different methods to improve these various processes.

With the emergence of third generation wireless networks for example UMTS (universal mobile telecommunications system), there is an interest in developing online games platforms that support multiplayer games across a wireless network. In the past, for example for second generation wireless networks, the data rates were not sufficient to support the bandwidth required for multiplayer online games. However, the enhanced data as provided by third generation networks has meant that online games platforms have become a reality for designers.

In the past, multiplayer online gaming was possible across fixed line networks, for example the Internet. Various types of games exist, for example so-called “first-person-shooter” games, wherein a player can play against some remote server, or alternatively can play against other players, or furthermore can join up with other players connected to the Internet and play against a computer. Other games are also possible, for example racing games, sports games, gambling games, third person adventure games, etc. However, in all of these games players actually participate in the action of the game.

It is an object of an embodiment of the present application to provide an online gaming service, in which a user of a wireless network has the choice of acting as a spectator of an online game played by other participants of the network.

The advantage of allowing a spectator to view an online game in action are: novice players can watch and learn techniques from more experienced players, spectators can take on new roles in the game but do not form part of the action as such (for example, a player might take the role of a cameraman following the action choosing to select different views that are seen by other spectators), building communities around games, generating revenue from spectators as well as players, etc.

### SUMMARY OF THE INVENTION

According to one aspect of the present invention there is provided an online gaming system enabling users connected to a communications network to interact with a computer game being played across the network, the system comprising at least one state engine for controlling the state of the game and at least one presentation engine for controlling the presentation to users of an output representing the state of the game; the state engine being arranged to enable one or more users to affect the state of the game by communicating with the state engine and thereby act as participant(s) in the game; and the presentation engine being arranged to enable at least one other user to affect the presentation of the output to one or more users acting as spectator(s) of the game by communicating with the presentation engine.

According to a further aspect of the present invention there is provided a method of interacting with a computer game being played online by users connected across a communications network, the method comprising: controlling the state of the game using a state engine; controlling the presentation to users of an output representing the state of the game; enabling one or more users acting as participant(s) in the game to affect the state of the game by communicating with the state engine; and enabling one or more users acting as spectator(s) of the game to affect the presentation of the output by communicating with the presentation engine.

According to another aspect of the present invention there is provided a wireless user terminal for playing a computer game online across a communication network, the user terminal comprising: a user interface for inputting and outputting information to a human user; at least one state engine for controlling the state of the game and at least one presentation engine for controlling the presentation of an output representing the state of the game to the user interface; and a network interface for transferring information to and from network.

According to yet another aspect of the present invention there is provided an online gaming system enabling users connected to a communications network to interact with a computer game being played across the network, the system comprising at least one state engine for controlling the state of the game in accordance with state rules and at least one presentation engine for controlling the presentation to the users of an output representing the state of the game; wherein: the state engine is arranged to enable one or more users to affect the state of the game by communicating with the state engine and thereby act as participant(s) in the game; and the state engine is arranged to vary the state rules in response to inputs received from the spectators indicating a support for a participant so as to vary the rules to favour the participant having the most support.

For a better understanding of the present invention and to show how the same may be carried into effect, reference will now be made by way of example to the accompanying drawings.

### BRIEF DESCRIPTION OF THE DRAWINGS

FIG. 1 shows a communication network in accordance with one embodiment of the present invention;

FIG. 2 shows a client terminal in accordance with one embodiment of the present invention;

FIG. 3 shows a further embodiment of a client as being a wireless gaming console according to another embodiment of the present invention;

FIG. 4 shows the basic internal architecture of the wireless gaming console according to a further embodiment of the present invention; and

FIG. 5 shows the internal structure of a gaming engine according to an embodiment of the present invention.

### DESCRIPTION OF THE PREFERRED EMBODIMENT

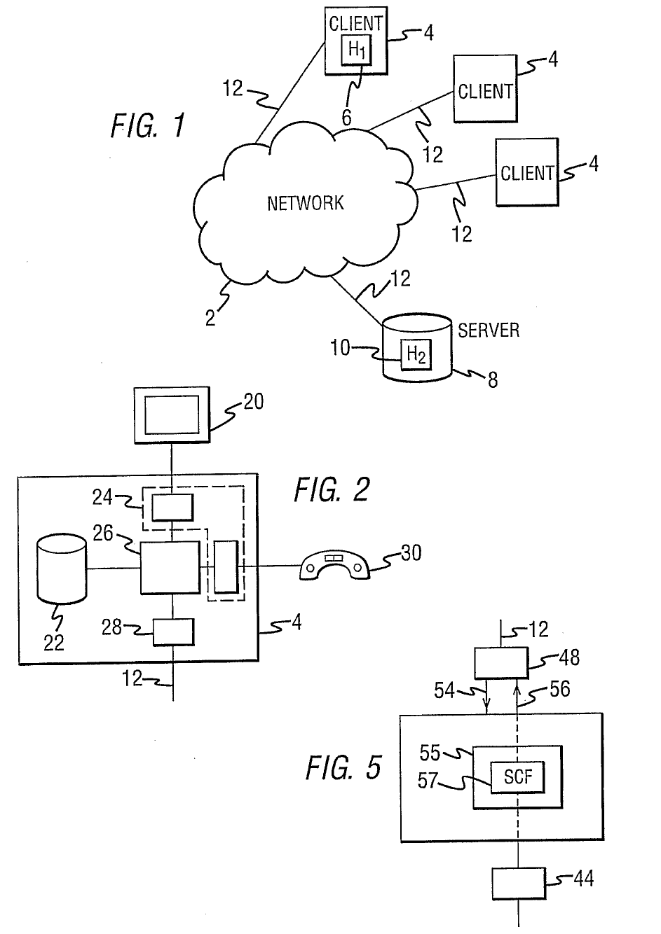

FIG. 1 shows a communication network 2 having a plurality of client terminals 4 and a server terminal 8, which are all connected to the network 2. FIG. 1 shows the basic architecture of an online gaming system and the various embodiments that the present invention may take. For example, in one embodiment the network 2 can be a wireless communication network, for example a PLMN (Public Land Mobile Network), which for example would comprise a plurality of BTSs (Base Transceiver Stations) each providing RF (Radio Frequency) cell coverage over a particular geographical area to MSs (Mobile Stations) which move throughout the coverage areas. The PLMN may be either a 2G (2^{nd} Generation) or a 3G (3^{rd} Generation) system, and/or the different technologies involved with such systems which are well known to those skilled in the art.

In the normal 2G GSM system, the BTSs are controlled by BSCs (Base Station Controllers) which in turn are controlled by a MSC (Main Switching Centre), which allows a particular PLMN to interface with other networks.

It should also be appreciated that all of the same technologies which apply for 2G and 2.5G systems can also be applied. For example, the PLMN network may make use of GPRS (General Packet Radio Servers) to increase the bandwidth of data rate transfer, or EDGE (Enhanced Data GSM Evolution) technologies.

If for example a GPRS network is used, the network 2 will also comprise standard GPRS elements such as a SGSN (Serving GPRS Support Node) and a GGSN (Gateway GPRS Support Node) which are not shown in FIG. 1.

It should also be appreciated in an alternative embodiment that the network 2 could be a fixed line network, for example the Internet, wherein the network would be comprised of various clients and servers, which may for example act as routing elements so that data can be transferred from a sending terminal to a receiving terminal. Presently the IP (Internet Protocol) is used to transfer and route data packets from a sending terminal to a receiving terminal through the intermediate network 2. It should also be appreciated that the sending and receiving terminals could either be a client terminal 4 or a server terminal 8 as shown in FIG. 1.

The communications links 12 which represent the communication path between the client terminals 4 and the network, as well as between the server terminal 8 and the network, can also be transmitted over different interfaces and/or mediums. In particular, in one embodiment one of the client terminals 4 could be a laptop computer or a desktop computer which are connected via a fixed line connection using for example a copper cable medium or a fiberoptic medium to transmit data to and from the network 2. In an alternative embodiment the interface 12 could be a wireless interface, for example using BlueTooth™ or for example using infrared transmission. Moreover, in a further embodiment the client terminal could be an RF terminal for example a mobile station or a mobile gaming console wherein the communication link 12 is an air interface which uses RF technology to communicate with the network 2.

It is now useful to consider the various online gaming scenarios that might exist in the basic network structure shown in FIG. 1.

Broadly speaking, online gaming can be split into three categories: i) a single-player game, ii) a two-player game, and iii) a multi-player game. For a single player game, a computer user operating a client terminal would interface with a host terminal located somewhere in the network.

The client terminal 4 could for example be a desktop computer as shown in FIG. 2. In this embodiment the desktop computer would comprise certain internal elements which allow the user to play his game online. In particular the desktop computer comprises an area of memory 22 where the software for the game to be played is stored. Also, an operating system (and/or processor) 26 will be needed to execute the computer program representing the game stored at memory location 22. The processor 26 will also connect to a user interface 24 and a network interface 28. The user interface 24 comprises elements which will enable the processor 26 of the client terminal to interface with the inputs received from the user, for example via a joystick 30, and output the resulting action of the game onto a display screen 20. The processor 26 is able to interface with the network via the interface 28, which for example could be a NIC (Network Interface Card).

In a single-player online gaming scenario, a client plays against a host computer, which acts as an opponent. The software for the host computer could be stored either on a client terminal indicated by H₁ 6 or stored on a server terminal 8 as indicated by H₂ 10.

In a two-player online gaming scenario, for example one client terminal 4 plays against another client terminal 4, both having the same gaming software 22 and both are connected to the same network 2. It should be appreciated, that it is also possible that a host computer may be situated on another terminal of the network and may distribute some of the game processing needed for the two players so that the resources of each of the client terminals 4 are not overburdened.

In a multi-game online gaming scenario, we have assumed that more than two users are taking part in the same game online. In this scenario, there are potentially many client terminals 4 that are connected to the network 2 and it would be desirable for a server 8 to act as a host computer H₂ 10 to host the software for the game.

The server terminal 8, for example, having a different specification to the client terminals 4 and therefore would be more suited to handle the increased processing requirements required in a multi-player game scenario.

It should be appreciated however that either a client terminal 4 or a server terminal 8 could act as a host computer for a particular game. Moreover, a dedicated online gaming server 8 could in fact be set up to act as a host computer for a plurality of online games which are simultaneously taking place across the network 2. Furthermore, the server terminal 8 could for example maintain a list of IP addresses of the various client terminals which are connected to it, and in this way is able to keep tags of the various players of the different games that are simultaneously being played.

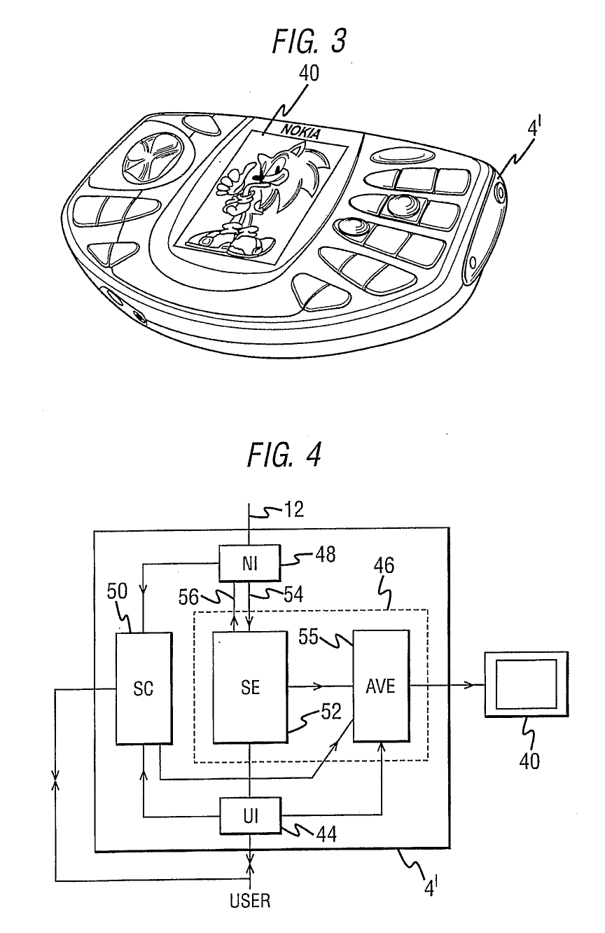

FIG. 3 shows an example of a wireless gaming console named the Nokia N-Gage™ mobile game deck, which may be used with an embodiment of the present invention. In the embodiment of FIG. 3, the gaming console would be similar to a wireless mobile station but has been adapted specifically for online gaming, whilst still retaining the call functionality of modern MSs. Therefore, referring back to the network diagram of FIG. 1, it should be appreciated that in the present embodiment one of the client terminals 4 could be the mobile game deck 4′ shown in FIG. 3. Therefore, it should be appreciated that online gamers can participate in a game with one another when all of the users have a mobile game deck or alternatively some of the players may have a mobile game deck, while others may use a normal desktop computer.

FIG. 4 shows in more detail the internal structure of the mobile game deck 4′ embodiment of FIG. 3.

FIG. 4 shows a network interface element 48 arranged to communicate with the network 2. For example the network interface 48 could be a BlueTooth™ interface card or an RF interface according to a preferred embodiment of the present invention. The network interface 48 connects to a so-called GE (Game Engine) 46. Broadly speaking the GE 46 can be thought of as consisting of two main blocks of functionality represented in FIG. 3 as a SE (State Engine) 52 and an AVE (Audio-Visual Engine) 55. That is, the SE 52 can be thought of in terms of a state machine representing the state of a game at any point in time. It can be seen that the state engine 52 is able to receive inputs from either the network 2 via the network interface 48 or from the user via the user interface 44. These inputs will alter the state of the game, for example if a user were to click on a certain key, the player in the game could move to the right or if a different key was pressed, for example the player could jump up. From the network side, a host computer or another computer could alter the state of the game, for example by sending inputs to the state engine via the network interface 48. Therefore, in summary the state engine is responsible for controlling the current state of the game and performing certain actions based thereon.

The state engine, when encountering various events, outputs signals to the AVE functionality 54. The AVE functionality would be responsible for outputting visual information to the user via the display screen 40, and/or might be responsible for synchronising the sound (audio) of the game in line with the actions taken by the different players of the game (not shown).

Therefore the SE 52 has events and transitions between these events depending on the inputs to the state machine. Furthermore, certain events will require output signals to be provided to the AVE 52 for outputting information to the user.

FIG. 4 also shows that the mobile game deck 4′ has a SC (Side Channel), which provides the necessary functionality for receiving and sending various voice or data messages over a wireless communications network. For example, the SE 50 is shown as being connected to the network interface 48 and the user interface 44. The SE therefore enables the user to receive any incoming calls or text messages received from different users of a wireless network, or indeed in an alternative embodiment from one of the participating online gamers.

Also, the user interface 44 allows the user to make a call to another MS connected to the wireless communications network, while simultaneously still being able to participate in an online game scenario.

According to a preferred embodiment of the present invention at least one of the users of the communication network is arranged to spectate on an online game being played by participants. That is, a user having a wireless game deck 4′ is able to watch a game being played online between different participants without having to actually take part in the action and therefore not having any effect on the SE 52 of the GE 46. The participants can fall into any of the categories as already described, in particular the participant may be a single user involved in a one-player game against a host computer. In this case, a second user is able to spectate on the game being played between the single user and the host computer. In an alternative embodiment, it is envisaged that the present invention provides even more benefit in the case of a multi-game scenario, wherein for example a user can be a spectator to a game played between a plurality of participants, but where the spectator does not need to actively participate in the game.

Various embodiments of the present invention provide many advantages. For example, players new to a particular game can spectate on a game in action and in so doing will learn the various techniques of the game from more experienced players. Also, users that act as spectators, might for example take on new roles which are linked to the game but do not necessarily form part of the action as such. For example, a player might take on the role of a cameraman that follows the action and in so doing chooses the views that are seen by the spectators and/or the participants.

FIG. 5 shows one embodiment of the present invention, which allows the user to act as a spectator as distinguished from a participant, wherein the spectator acts as a cameraman for the game. In particular, FIG. 5 shows one embodiment of the present invention in which SCF (Spectator-Client Functionality) 57 is contained within the game engine 46 of the user which will act as a spectator-client for the game. In particular, the embodiment shows that the SCF 57 is located within the AVE 55 of the game engine. The SCF can be seen as providing communication between the user interface 44 and the network interface 48 over the path 56. The communication path 56 is shown as extending in the direction from the user interface 44 through the SCF 57 to the network interface 48. In particular, this demonstrates that the user which wishes to act as a spectator client passes his input signals (for camera control) to the user interface 44 which forwards them on to the SCF 57 within the gaming engine 46, wherein the SCF alters the display functionality of the AVE 55 in such a manner that the camera angle is controlled by the spectator. Moreover, if it is decided that the spectator client can act as a cameraman for both of the spectators as well as the participants, the line 56 is shown as extending from the SCF towards the network interface 48. In so doing, the SCF functionality 56 in the spectator client is able to convey the updated information within the gaming engine of the spectator client on to the other users of the communication network which are connected to the online game. In particular, the signals output from the spectator client can be used by other spectator clients and indeed also the participant clients which are connected to the network.

In an alternative embodiment, it should be understood that the SCF 57 placed within the game engine 46 of the user, could be replaced with a PCF (Participant-Client Functionality), which is not shown. It needs to be understood that a user connected to the communication network 2 that has a gaming engine which is loaded with PCF instead of SCF will only function as an active participant in the game and as such may decide that he does not wish a spectator to control the camera angle of the game.

Therefore, at least one embodiment of the present invention is concerned with providing a wireless communication network having at least two participants, that participate actively and directly in controlling the actions of the game and wherein the functionality is implemented by loading participant client functionality into the corresponding respective user mobile game deck's. Moreover, spectators in such a game between multiple participants are defined by loading spectator client functionality 57 into the corresponding user mobile game deck's.

In summary, whereas participants in an online game participate actively and directly in the game, spectators adopt an indirect and passive role and do not form part of the action as such.

The technical feature which best distinguishes a participant from a spectator, is that spectator client functionality is loaded into the AVE 55 part of the game engine 46, instead of the actual SE 52 of the game engine 46. In effect, this means that the spectator client has no effect on the state machine contained within SE 52 but rather controls the audio/visual outputs to users (via the AVE 55). Therefore, the distinction needs to be made between the various states of the game engine, which can only be controlled by the participant as opposed to the manner in which information is chosen to be presented to the spectators.

Having spectators it is possible to build communities around games, for example to provide support for successful players or teams. It is also possible to generate more revenue for the service providers from spectators as well as the participants of the game. At the same time, it widens the appeal of network games in the mobile arena as it allows inexperienced players to quickly pick up the techniques of more experienced players from spectating on such games. More importantly, spectators can see the game from different perspectives to the players. For example in a maze game, the spectators' viewpoints might be high above the maze with a view of all the players. It should also be appreciated that the SCF 57 can be adapted uniquely for each spectator so they are each able to generate different views from which they can spectate on the action.

In an embodiment of a wireless communication system, the mobile game decks could for example have an interface allowing the option of users to login to a “games service” and then select from that particular game. If there are already games in progress, players can join the game as either participants or spectators. Also, the use of the side channel 50 enables news of clashes between top players to be broadcast, for example via SMS or email amongst a gaming community, and players would then be able to “tune in” at a certain time to watch the game being played (i.e. just as they might for a big sporting event).

Other embodiments are that spectators could for example choose where they sit in a virtual arena (i.e. each spectator having his own camera angle). In another embodiment, the spectators' interaction can be fed back to the participants in the game, for example, certain clients could hear cheering and this could potentially spur the relevant participants on to play better. In another embodiment the spectators can communicate with each other and discuss the action as it is unfolding using the side channel. In another embodiment the spectators' view of the playing field may allow them to see everything that is going on, rather than a much smaller view that the players have, for example the difference between sitting in a football stadium and standing on the pitch.

According to a different embodiment of the present invention, some advantage may be given to a particular participant based on how many supporters they have, for example home advantage. In this embodiment of the present invention, the spectators are in fact able to affect the SE 52 and not only the AVE 55 as described in the previous embodiments. For example, if the game being played was for example a football game, wherein the participants in a game are able to select before the game starts, the relevant players for their team. If each participant was a manager of a particular football team, the participant could select his players depending on certain player attributes, for example speed, skill, stamina, etc. However, if a particular football team is playing at home, these attributes could be automatically increased. For example, it would be expected that football players in a normal home game would probably have more stamina especially in the latter period of the game when home supporters would lift their spirits by cheering them on. Similarly, in an online game where each participant has its own following of supporters/spectators, a participant having more supporters than another participant could be given a particular advantage, for example as described above where the participant having the largest number of spectators will have players in his football team whose attributes are enhanced. It should be understood that in this embodiment the spectators will have an effect on the SE, which for example could count the number of spectators for each participant and depending on the participant having the largest number of spectators, would update the SE so that the participant with the most spectators has enhanced player attributes

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An online gaming system enabling users connected to a communications network to interact with a computer game being played across the network, the system comprising at least one state engine for controlling the state of the game and at least one presentation engine for controlling the presentation to users of an output representing the state of the game;
the state engine being arranged to enable one or more users to affect the state of the game by communicating with the state engine and thereby act as participant(s) in the game; and
the presentation engine being arranged to enable at least one other user to affect the presentation of the output to one or more users acting as spectator(s) of the game by communicating with the presentation engine.

2. The gaming system according to claim 1, wherein the system has a state engine which is shared by the users, but each user has its own presentation engine.

3. The gaming system according to claim 1, wherein each user has its own state engine and its own presentation engine.

4. The gaming system according to claim 1, wherein the system has a state engine and a presentation engine which are shared by the users.

5. The gaming system according to any preceding claim 1, wherein the system further comprises a side channel for communicating at least one of voice and data to other users while the game is being played.

6. The gaming system according to any preceding claim 1, wherein the online game is played in a substantially real time manner across the network.

7. The gaming system according to any preceding claim 1, wherein the network is a wireless communications network.

8. The gaming system according to claim 1, wherein the user terminals are wireless terminals.

9. The gaming system according to claim 1, wherein at least one of the spectators acts as a cameraman for affecting the virtual viewing position and angle of the game as seen by the other spectators.

10. The gaming system according to claim 9, wherein said cameraman is also arranged to affect the view of the game as seen by the participants.

11. The gaming system according to claim 9, wherein said spectator acts as a cameraman using camera circuitry stored in a presentation engine.

12. A method of interacting with a computer game being played online by users connected across a communications network, the method comprising:
controlling the state of the game using a state engine;
controlling the presentation to users of an output representing the state of the game;
enabling one or more users acting as participant(s) in the game to affect the state of the game by communicating with the state engine; and
enabling one or more users acting as spectator(s) of the game to affect the presentation of the output by communicating with the presentation engine.

13. A wireless user terminal for playing a computer game online across a communication network, the user terminal comprising:
a user interface for inputting and outputting information to a human user;
at least one state engine for controlling the state of the game and at least one presentation engine for controlling the presentation of an output representing the state of the game to the user interface; and
a network interface for transferring information to and from network;
wherein the state engine is arranged to enable a user of the terminal to affect the state of the game by communicating with the state engine and thereby act as a participant in the game, and the presentation engine is arranged to enable a user of the terminal to affect the presentation of the output to one or more other users acting as spectator(s) of the game by communicating with the presentation engine.

14. The user terminal according to claim 13, further comprising a side channel for transferring further information to and from the network.

15. The user terminal according to claim 14, wherein the further information transferred from the side channel is at least one of voice, SMS and email data.

16. An online gaming system enabling users connected to a communications network to interact with a computer game being played across the network, the system comprising at least one state engine for controlling the state of the game in accordance with state rules and at least one presentation engine for controlling the presentation to the users of an output representing the state of the game; wherein:
the state engine is arranged to enable one or more users to affect the state of the game by communicating with the state engine and thereby act as participant(s) in the game; and
the state engine is arranged to vary the state rules in response to inputs received from the spectators indicating a support for a participant so as to vary the rules to favour the participant having the most support.
